(19) United States
(12) Patent Application Publication
(10) Pub. No.: US 2019/0010882 A1
(43) Pub. Date: Jan. 10, 2019

(54) METHOD FOR REGENERATING A PARTICLE FILTER FOR AN INTERNAL COMBUSTION ENGINE

(71) Applicant: GM GLOBAL TECHNOLOGY OPERATIONS LLC, Detroit, MI (US)

(72) Inventors: Alexander Michel, Rheinbollen (DE); Jochen Grieser, Seligenstadt (DE); Rafat Hattar, Royal Oak, MI (US); Markus Kraft, Bad Camberg (DE); Simon Schiesser, Mainz (DE); Daniel Siebert, Mainz (DE)

(73) Assignee: GM GLOBAL TECHNOLOGY OPERATIONS LLC, Detroit, MI (US)

(21) Appl. No.: 16/030,563

(22) Filed: Jul. 9, 2018

(30) Foreign Application Priority Data
Jul. 8, 2017 (DE) 102017006499.7

(51) Int. Cl. F02D 41/02

(52) U.S. Cl. CPC F02D 41/029; F02D 41/025; F02D 2200/0812; F02D 2041/026; F02D 2200/0802

(57) ABSTRACT

A method and system for regenerating a gasoline particle filter of an internal combustion engine is provided in which a value (Q) for a quantity of soot collected inside of the gasoline particle filter and a value (T) for a temperature of the gasoline particle filter are determined. The internal combustion engine is operated in a lean mode when the value (Q) for the soot quantity is greater than a first threshold, and the value (T) for the temperature of the gasoline particle filter is greater than a threshold.

### CROSS-REFERENCE TO RELATED APPLICATION

This application claims priority to German Patent Application No. 10 2017 006 499.7, filed Jul. 8, 2017, which is incorporated herein by reference in its entirety.

### TECHNICAL FIELD

The present disclosure relates to an internal combustion engine, for example an internal combustion engine of a motor vehicle, which is provided with a particle filter. More precisely, the present disclosure relates to a method for regenerating a gasoline particle filter (BPF) of a gasoline internal combustion engine.

### BACKGROUND

As is well known, exhaust aftertreatment systems of internal combustion engines of a drive system can, in addition to other aftertreatment devices, have a particle filter that collects liquid and solid particles as well as soot particles in a porous, adsorbing substrate structure, while allowing the exhaust gases to flow through.

The efficiency of a particle filter can be preserved either by replacing the component or through periodic cleaning, a so-called regeneration process; however, a regeneration process is generally preferred to avoid operational interruptions.

A regeneration process makes it possible to remove soot collected inside of the particle filter in a soot burning process, which takes place inside of the particle filter. The regeneration process can be performed when the temperature inside of the particle filter is above a specific temperature level (e.g., 500° C.), and enough oxygen is available in the exhaust aftertreatment system.

In internal combustion engines with homogeneous, stoichiometric combustion systems (e.g., gasoline engines), a regeneration process usually takes place during a fuel cut-off phase, when no fuel is supplied to the engine cylinders, and the engine pistons pump large amounts of oxygen to a gasoline particle filter (BPF). Even under these circumstances, the temperature value inside of the gasoline particle filter (BPF) must lie above a predetermined threshold, so that a regeneration process can be started (automatic regeneration).

By contrast, if no automatic regeneration is possible, active regeneration is necessary to prevent the gasoline particle filter (BPF) from becoming overloaded/damaged. Overloading the gasoline particle filter (BPF) with soot leads to a rise in the exhaust counter-pressure, which in turn can lead to a loss in torque/power. If the temperature inside of the gasoline particle filter (BPF) and the quantity of oxygen supplied to the gasoline particle filter (BPF) are high or large enough, an uncontrolled burning can further come about inside of the particle filter.

Within the framework of the latest emission standards, the limits for particle emission were greatly lowered, which resulted in an increased use of particle filters in the exhaust aftertreatment systems of direct injection engines. However, in gasoline engines, the engine parameters are changed to perform an active regeneration of the gasoline particle filter (BPF), for heating the gasoline particle filter (BPF) to a specific level and conveying oxygen into the exhaust system.

Consequently, active regenerations have negative effects on the fuel consumption and emissions of an internal combustion engine.

In view of the above statements, there is need for a method of operating the aftertreatment system in which an active regeneration is only initiated when necessary.

### SUMMARY

One embodiment of the disclosure provides a method for implementing a regeneration of a gasoline particle filter of an internal combustion engine. A value for a quantity of soot collected inside of the gasoline particle filter is determined. A value for a temperature of the gasoline particle filter is also determined. The internal combustion engine is operated in a lean mode when the value for the soot quantity is greater than a first threshold, and the value for the temperature of the gasoline particle filter is greater than a threshold.

As a result, the method enables a needs-oriented regeneration process based on the quantity of soot collected inside of the particle filter and the particle filter temperature. It is determined whether a regeneration process is actually necessary for reducing the negative effects on the fuel consumption and emissions of an internal combustion engine based on unnecessary regeneration processes.

In another aspect of the embodiment, the method can further include heating the gasoline particle filter if the value for the temperature of the gasoline particle filter is less than its threshold, and the value for the soot quantity is greater than a second threshold which is greater than the first threshold. As a result, the method prevents the quantity of soot collected inside of the gasoline particle filter from reaching values that could lead to torque and power losses by forcing the driver to continue the drive until the regeneration process has concluded.

In another aspect of the method, the determined value for the quantity of soot collected inside of the gasoline particle filter is estimated.

In another aspect of the method, operating the internal combustion engine in a lean mode involves increasing a quantity of oxygen supplied to the gasoline particle filter by increasing an air/fuel ratio of the air/fuel mixture supplied to the internal combustion engine. As a result, the method enables a regeneration process without controlling the heating parameters, and thus without influencing fuel consumption.

In another aspect of the method, heating the gasoline particle filter involves operating the ICE at a higher engine load.

In another aspect of the present disclosure, the method according to the present disclosure can be implemented using a computer program, which consists of a program code for executing all steps of the method described above, as well as in the form of a computer program product that contains the computer program. The method can also be configured as an electromagnetic signal, wherein the signal is modulated in such a way as to carry a sequence of data bits, which yield a computer program for executing all steps of the method.

Another embodiment of the disclosure provides an internal combustion engine, which includes an aftertreatment system with a gasoline particle filter and an electronic controller configured to determine a value for a quantity of soot collected inside of the gasoline particle filter, determine a value for a temperature of the gasoline particle filter, and operate the internal combustion engine in a lean mode if the value for the soot quantity is greater than a first threshold, and the value for the temperature of the gasoline particle filter is greater than a threshold.

This embodiment achieves essentially the same effects as the method described above, in particular those of reducing the fuel consumption and emissions of an internal combustion engine based on unnecessary regeneration processes.

Additional objects, desirable features and characteristics will become apparent from the subsequent summary and detailed description, and the appended claims, taken in conjunction with the accompanying drawings and this background.

### BRIEF DESCRIPTION OF THE DRAWINGS

The present disclosure will hereinafter be described in conjunction with the following drawing figures, wherein like numerals denote like elements.

FIG. 1 schematically depicts a motor vehicle;

FIG. 2 shows an internal combustion engine of the motor vehicle according to the A-A cross section on FIG. 1; and

FIG. 3 is a flowchart that illustrates a method for operating the aftertreatment system on FIG. 3 according to an embodiment of the present disclosure.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

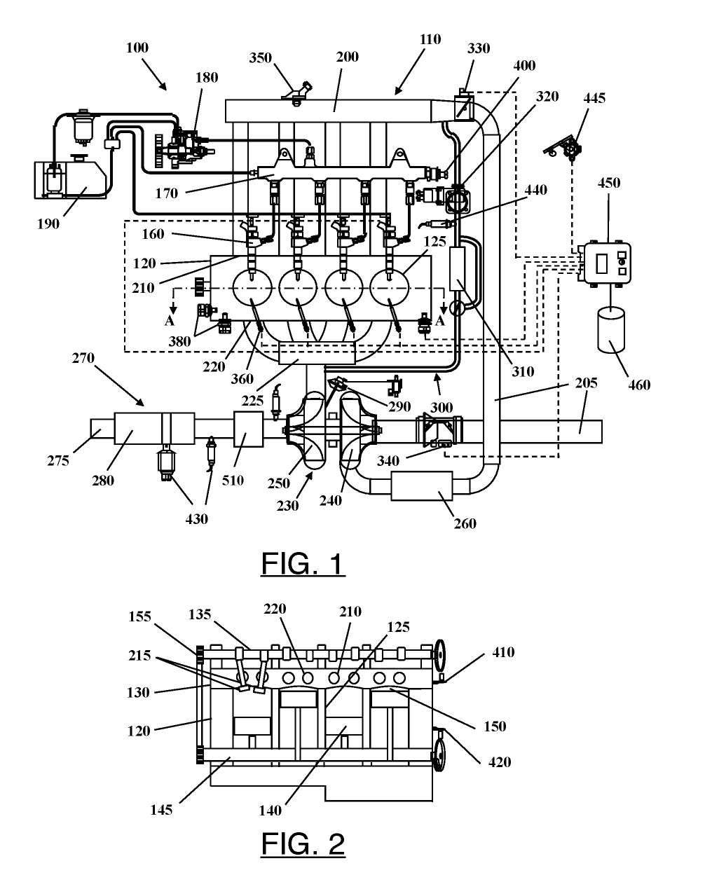

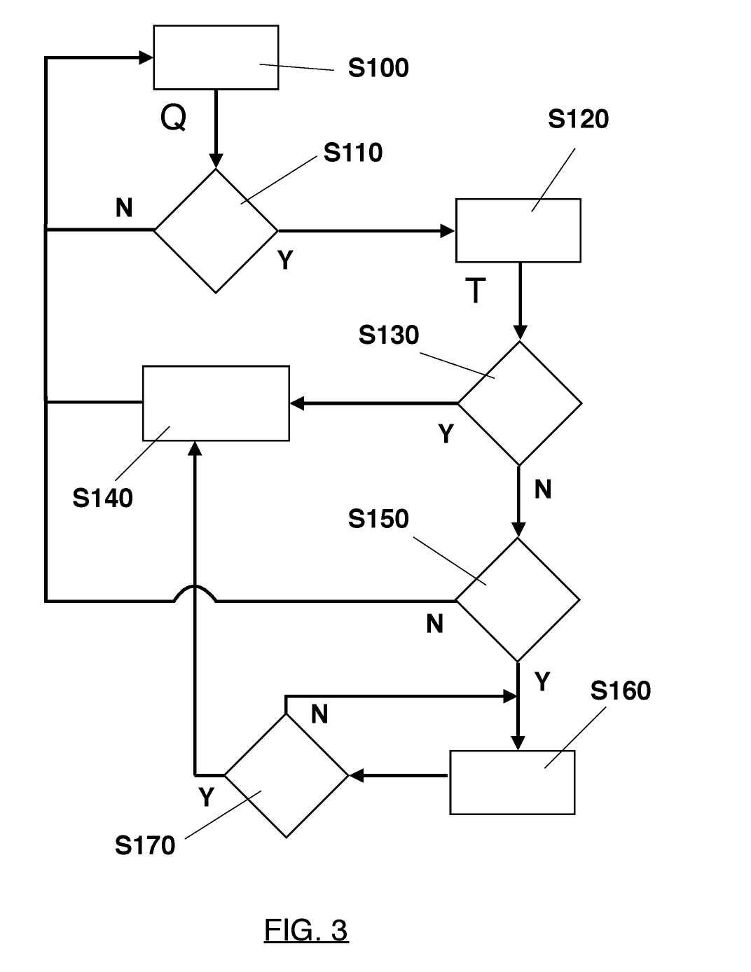

Several embodiments can involve a motor vehicle 90, which consists of a drive system 100 that is depicted on FIGS. 1 and 2, and has an internal combustion engine (ICE) 110. In this example, the ICE 110 is a positive-ignition engine (e.g., a gasoline engine). In other embodiments, the ICE 110 could be a compression-ignition engine (e.g., a diesel engine). The ICE 110 has an engine block 120 that defines at least one cylinder 125 with a piston 140, which has a clutch that turns the crankshaft 145. A cylinder head 130 works together with the piston 140 to define a combustion chamber 150. An air/fuel mixture (not depicted) is introduced into the combustion chamber 150 and combusted, resulting in hot, expanding combustion gases that cause the piston 140 to move back and forth. The fuel is made available by at least one fuel injector 160, and the air by at least one intake 210. The fuel is guided under a high pressure from a fuel rail 170, which is connected in a fluid-conducting manner with a high-pressure pump 180 that increases the pressure of the fuel coming from a fuel source 190 to the fuel injector 160. Each of the cylinders 125 has at least two valves 215, which are operated by a camshaft 135 that rotates at the same time as the crankshaft 145. The valves 215 selectively allow air from the intake 210 into the combustion chamber 150, and alternatingly allow the discharge of exhaust gases through the exhaust 220. In several examples, a camshaft displacement system 155 is used to selectively change the chronological sequence between the camshaft 135 and crankshaft 145.

The air can be fed to the air intake(s) 210 via an intake manifold 200. An air intake line 205 supplies ambient air to the intake manifold 200. In other embodiments, a throttle valve 330 can be selected to regulate the air flow to the intake manifold 200. In additional embodiments, use is made of a system for compressed air, for example a turbocharger 230 with a compressor 240, which rotates together with a turbine 250. The rotation of the compressor 240 increases the pressure and temperature of the air in the line 205 and intake manifold 200. An intercooler 260 contained in the line 205 can reduce the temperature of the air. The turbine 250 rotates during the inflow of exhaust gases coming from an exhaust manifold 225, which guides exhaust gas from the exhaust 220 through a series of guide vanes, before it is expanded by the turbine 250. This example shows a turbine having a variable geometry (VGT) with a VGT actuator 290 designed to move the guide vanes or blades, so that the blades alter the flow of exhaust gas through the turbine 250. In other embodiments, the turbocharger 230 can have a fixed geometry and/or a wastegate.

The exhaust gases exit the turbine 250, and are guided to an exhaust system 270. The exhaust system 270 can have an exhaust pipe 275, which has one or several exhaust aftertreatment devices 280. Aftertreatment devices can be any devices with which the composition of the exhaust gases can be changed. Without being limited thereto, however, several examples for aftertreatment devices 280 include catalytic (two- and three-way) converters, oxidation catalysts, NOx traps for lean operation (lean NOx traps), hydrocarbon adsorbers, systems for selective catalytic reduction (SCR) and particle filters, in particular a gasoline particle filter (BPF) 510. Other embodiments can involve an exhaust gas recirculation system (EGR) 300 connected with the exhaust manifold 225 and intake manifold 200. The EGR system 300 can have an EGR cooler 310 for reducing the temperature of the exhaust gases in the EGR system 300. An EGR valve 320 regulates the flow of exhaust gases in the EGR system 300.

The drive system 100 can further have an electronic control module (ECM) 450, which communicates with one or several sensors and/or devices connected with the ICE 110. The ECM 450 can receive reception signals from various sensors, which are set up to generate the signals, which are proportional to various physical parameters in conjunction with the ICE 110. Without being limited thereto, however, the sensors consist of an air mass flow and temperature sensor 340, a pressure and temperature sensor 350 for the manifold, a sensor 360 for the pressure in the combustion chamber, sensors 380 for the coolant and oil temperature and/or the accompanying fill level, a pressure sensor 400 for the fuel, a camshaft position sensor 410, a crankshaft position sensor 420, sensors 430 for the pressure and temperature of the exhaust gases, an EGR temperature sensor 440, a position sensor 445 for the gas pedal as well as a position sensor 446 for the brake pedal. In addition, the ECM 450 can send output signals to various controllers for controlling the operation of the ICE 110, for example, but not exclusively, to the VGT actuator 290, to the camshaft adjustment system 155, to the clutch 515 and to the starter motor 520. Let it be noted that dashed lines are used to denote various connections between the various sensors, devices and ECM 450, wherein others have been omitted for the sake of clarity.

The control module 450 can have a digital microprocessor unit (CPU) connected in terms of data with a memory system and a bus system. The CPU is designed to process commands in the form of a program stored in the memory system 460, acquire input signals from the data bus and send output signals to the data bus. The memory system 460 can have various storage media, such as optical, magnetic, solid-state and other nonvolatile media. The data bus can be configured to transmit analog and/or digital signals to the various sensors and control modules and receive them from the latter, and to modulate these signals. The program can be set up in such a way as to be able to embody or implement the methods described herein, so that the CPU can execute the steps of such methods and thereby control the ICE 110.

The program stored in the memory system 460 may be supplied to the control module from outside by wire or radio. Outside of the drive system 100, it is routinely encountered on a computer program product, which is also referred to as a computer- or machine-readable medium in the field, and to be understood as a computer program code on a carrier. The carrier can here be transitory or non-transitory in nature, so that reference could also be made to a transitory or non-transitory nature of the computer program product.

One example for a transitory computer program product is a signal, e.g., an electromagnetic signal, such as an optical signal, which is a transitory carrier for the computer program code. The computer program code can be carried by modulating the signal with a conventional modulation process, such as QPSK, for digital data, so that binary data representing the computer program code are imprinted onto the volatile electromagnetic signal. For example, such signals are used when a computer program code is wirelessly transmitted to a laptop by way of a Wi-Fi connection.

In the case of a non-transitory computer program product, the computer program code is embodied in a substrate-bound storage medium. The storage medium is then the aforementioned non-transitory carrier or computer readable medium, so that the computer program code is stored permanently or non-permanently in a retrievable manner or on the storage medium. The storage medium can be a conventional type of the kind known in the field of computer technology, for example a flash memory, an Asic, a CD or the like.

Instead of an engine control module 450, the drive system 100 can have some other type of processor to provide the electronic logic, e.g., an embedded controller (in English: embedded controller), an onboard computer or any other kind of processor that can be used in a vehicle.

A drive system including an ICE 110 with homogeneous, stoichiometric combustion, e.g., a gasoline engine, is usually provided with a gasoline particle filter (BPF) 510, for collecting the majority of the soot generated by the combustion process. As long as the soot is gradually collected and accumulates in the BPF 510, the value of the exhaust gas counter-pressure, i.e., the pressure of the exhaust gases generated by the ICE 110, rises to overcome the hydraulic resistance of the exhaust system, so that the gases can be emitted into the atmosphere.

The ECM 450 can be configured to perform a regeneration process for reducing the quantity of soot collected in the BPF 510 and the exhaust gas counter-pressure. The regeneration processes can primarily take place during a so-called fuel cut-off phase. Every time the driver steps off of the gas pedal, the ECM 450 can generally prevent fuel from being conveyed to the engine cylinders 125, for example by keeping all fuel injectors 160 closed. During this phase, the back and forth movement of the pistons 140 in the corresponding cylinders 125 only has the effect of pumping fresh air, and hence oxygen, from the intake manifold 200 to the exhaust system 270.

If the ICE 100 goes through a fuel shut-off phase and the temperature of the BPF 510 is high enough (e.g., higher than 500° C.), the large quantity of oxygen coming from the intake manifold 200 triggers a spontaneous combustion of the soot collected inside of the BPF 510, so that an automatic regeneration process is carried out.

The loss by the ICE of torque/power to be traced back to a high exhaust gas counter-pressure depends primarily on the exhaust gas throughput. The exhaust gas throughput depends primarily on the driving profile used by the consumer. If the driving profile used by the consumer requires no high engine load, there will be no strong increase in the exhaust gas counter-pressure, and thus there will be no significant loss in engine power. Driving on a highway at an essentially constant speed with the ICE operating at an average RPM, requires no high engine load. A shut-off phase is also not to be expected for this driving profile.

To master this scenario, the ECM 450 can be configured to perform a need-oriented regeneration process illustrated in the flowchart on FIG. 3, in which the ECM determines whether a regeneration process is actually necessary. As a result, the driving profile used by the consumer and/or the temperature of the ambient air make it possible to reduce the negative effects on fuel consumption and the emission of an internal combustion engine based on unnecessary regeneration processes.

According to the needs-oriented regeneration process, the ECM 450 can be configured to determine the current value Q of the quantity of soot collected inside of the BPF 510 (block S100).

The current value Q for the soot quantity can be estimated using a corresponding soot level estimating strategy. The soot level estimating strategy is a strategy for estimating the quantity of soot collected inside of the particle filter 280, wherein both the normal operation of the ICE 110 and the regenerations are considered. A suitable soot level estimating strategy is generally known in the art, and can be based upon a physical model of the BPF 510 containing several operating parameters as the input, for example the temperature of the BPF 510, the air/fuel ratio of the air/fuel mixture supplied to the engine cylinders 125, the temperature of the ICE 110, and the time spent under the various conditions as an example.

The ECM 450 can be configured to check, based on the current value Q for the soot quantity, whether the current value Q for the quantity of soot collected inside of the BPF 510 is greater than a first predetermined threshold, or conversely whether the current value Q for the quantity of soot collected inside of the BPF 510 is less than the first predetermined threshold (block S110).

The first predetermined threshold for the soot quantity can involve a soot value that causes the drive system 100 not to exceed the particle emission limits. The value may be one that is predetermined within the framework of tests and stored in the memory system.

The ECM 450 can be configured not to activate a regeneration process if the current value Q for the quantity of soot collected inside of the BPF 510 is less than the first predetermined threshold.

The ECM 450 can be configured to determine a current value T for the BPF temperature if the current value Q for the quantity of soot collected inside of the BPF 510 is greater than the first predetermined threshold (block S120). The current value T for the BPF temperature can be measured using the temperature sensor 430.

The ECM 450 can be configured to check, based on the current value T for the BPF temperature, whether the current value T for the BPF temperature is greater than a first predetermined threshold, or conversely whether the current value T for the BPF temperature is less than the first predetermined threshold (block S130).

The first predetermined threshold for the BPF temperature can involve a temperature value that enables a spontaneous combustion of the soot collected inside of the BPF 510. The value can be one that is predetermined within the framework of tests and stored in the memory system.

The ECM 450 can be configured to activate a lean operation for enabling a regeneration process of the BPF 510 if the current value T for the BPF temperature is greater than the first predetermined threshold (block S140).

In particular, the ECM 450 can be configured to increase the quantity of oxygen supplied to the particle filter 280 by increasing the air/fuel ratio of the air/fuel mixture 125 introduced into the engine cylinder (i.e., by making the air/fuel mixture leaner) and/or by interrupting the fuel supply to one or several of the engine cylinders 125, so that these cylinders are no longer supplied with fuel, and their effect is only one of pumping fresh air and oxygen to the particle filter 280.

The process for regenerating the BPF (510) is active as long as the current value T for the BPF temperature is greater than the first predetermined threshold, and the current value Q for the quantity of soot collected inside of the BPF 510 is greater than the first predetermined threshold.

The ECM 450 can be configured to deactivate the regeneration process if the soot load was burned off completely, i.e., if the current value Q for the quantity of soot collected inside of the BPF 510 is less than the first predetermined threshold. Under these conditions, the driver is not given any indication to continue driving to complete the regeneration process.

By contrast, if the current value T for the BPF temperature is less than the first predetermined threshold, the ECM 450 can be configured to check whether the current value Q for the soot quantity collected inside of the BPF 510 is greater than a second predetermined threshold (block S150).

The second predetermined threshold for the soot quantity can involve the maximum soot value that results in the BPF being overloaded with soot, and triggers a strong rise in the exhaust gas counter-pressure, which in turn can lead to loss in torque/power and bring about an uncontrolled combustion with unfavorable particle emissions if the temperature inside of the BPF is high enough. The second predetermined threshold for the soot quantity can involve a value that is predetermined within the framework of tests and stored in the memory system.

The ECM 450 can be configured to change several of the parameters of the ICE 110 for actively increasing the temperature of the BPF 510, and thereby heat the BPF 510 if the current value Q for the quantity of soot collected in the BPF 510 is greater than the second predetermined threshold (block S160). For example, the ICE 110 can be operated with a higher engine load than necessary, which generates hotter exhaust gases, or the ECM 450 can be configured to change the ignition time, i.e., moving it up or back.

The ECM 450 can be configured to check, based on the current value T for the BPF temperature, whether the current value T for the BPF temperature is greater than a second predetermined threshold, or conversely whether the current value T for the BPF temperature is less than the second predetermined threshold (block S170).

The ECM 450 can be configured to further change several of the parameters of the ICE 110 for further actively increasing the temperature of the BPF 510 if the second current value T for the BPF temperature is less than the second predetermined threshold (block S160).

The ECM 450 can be configured to activate a lean operation if the second current value T for the BPF temperature is greater than the second predetermined threshold (block S140). For example, if regeneration is repeatedly interrupted due to driving cycles being too short, the driver is forced under these conditions to continue driving until the regeneration process has concluded.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment as contemplated herein. It should be understood that various changes may be made in the function and arrangement of elements described in an exemplary embodiment without departing from the scope of the invention as set forth in the appended claims.

1-10. (canceled)

11. A method for regenerating a gasoline particle filter of an internal combustion engine, comprising:
determining a value for a quantity of soot collected inside of the gasoline particle filter;
determining a value for a temperature of the gasoline particle filter;
operating the internal combustion engine in a lean mode when the value for the soot quantity is greater than a first threshold, and the value for the temperature of the gasoline particle filter is greater than a temperature threshold.

12. The method according to claim 11, further comprising heating the gasoline particle filter if the value for the temperature of the gasoline particle filter is less than the temperature threshold, and the value for the soot quantity is greater than a second threshold, wherein the second threshold is greater than the first threshold.

13. The method according to claim 12, wherein the determined value for the quantity of soot collected inside of the gasoline particle filter is estimated.

14. The method according to claim 12, wherein the step of heating the gasoline particle filter comprises the step of operating the ICE with a higher engine load.

15. The method according to claim 11, wherein the step of operating the internal combustion engine in a lean mode comprises increasing the quantity of oxygen supplied to the gasoline particle filter by increasing an air/fuel ratio of the air/fuel mixture supplied to the internal combustion engine.

16. A non-transitory computer readable medium comprising a program code having instruction, which when executed on a processor, performs the method according to claim 11.

17. A engine controller for regenerating a gasoline particle filter of an internal combustion engine, comprising an electronic control module configured to:
determine a value for a quantity of soot collected inside of the gasoline particle filter;
determine a value for a temperature of the gasoline particle filter;
operate the internal combustion engine in a lean mode if the value for the soot quantity is greater than a first threshold, and the value for the temperature of the gasoline particle filter is greater than a temperature threshold.

18. The engine controller according to claim 17, wherein the electronic control module is further configured to heat the gasoline particle filter if the value for the temperature of the gasoline particle filter is less than the temperature threshold, and the value for the soot quantity is greater than a second threshold, wherein the second threshold is greater than the first threshold.

19. The engine controller according to claim 18, wherein the electronic control module is configured to operate the ICE with a higher engine load for heating the gasoline particle filter.

20. The engine controller according to claim 18, wherein the determined value for the quantity of soot collected inside of the gasoline particle filter is estimated.

21. The engine controller according to claim 17, wherein the electronic control module is configured to increase the quantity of oxygen supplied to the gasoline particle filter by increasing an air/fuel ratio of the air/fuel mixture supplied to the internal combustion engine for operating the internal combustion engine in the lean mode.

22. An internal combustion engine, comprising an aftertreatment system with a gasoline particle filter and an electronic control module, wherein the electronic control module is configured to
determine a value for a quantity of soot collected inside of the gasoline particle filter;
determine a value for a temperature of the gasoline particle filter;
operate the internal combustion engine in a lean mode if the value for the soot quantity is greater than a first threshold, and the value for the temperature of the gasoline particle filter is greater than a temperature threshold.

23. The internal combustion engine according to claim 22, wherein the electronic control module is further configured to heat the gasoline particle filter if the value for the temperature of the gasoline particle filter is less than the temperature threshold, and the value for the soot quantity is greater than a second threshold, wherein the second threshold is greater than the first threshold.

24. The internal combustion engine according to claim 23, wherein the electronic control module is configured to operate the ICE with a higher engine load for heating the gasoline particle filter.

25. The internal combustion engine according to claim 23, wherein the determined value for the quantity of soot collected inside of the gasoline particle filter is estimated.

26. The internal combustion engine according to claim 22, wherein the electronic control module is configured to increase the quantity of oxygen supplied to the gasoline particle filter by increasing an air/fuel ratio of the air/fuel mixture supplied to the internal combustion engine for operating the internal combustion engine in the lean mode.
